(19) United States
(12) Patent Application Publication
(10) Pub. No.: US 2008/0105837 A1
(43) Pub. Date: May 8, 2008

(54) SENSOR FOR DETECTING CONTAMINANTS AND/OR RAIN AND METHOD FOR OPERATING A SENSOR

(75) Inventor: Bernd Mack, Remshalden (DE)

Correspondence Address: REISING, ETHINGTON, BARNES, KISSELLE, P.C., P O BOX 4390, TROY, MI, 48099-4390, US

(73) Assignees: Schefenacker Vision Systems Germany GmbH, Schwaikheim (DE); Schefenacker Patents S.a.r.l., Luxembourg (LU)

(21) Appl. No.: 11/854,179

(22) Filed: Sep. 12, 2007

(30) Foreign Application Priority Data
Sep. 13, 2006 (DE) 102006044792.1

(51) Int. Cl. G01N 21/55

(52) U.S. Cl. 250/564; 250/574; 356/445

(57) ABSTRACT

The invention relates to a sensor to detect contaminants and/or water with at least one transmission unit (12, 112) and at least one receiver unit (16, 116) as well as a test surface (22, 122) in which the deposit (30, 32) can be detected on the test surface (22, 122) by a light beam (24, 26; 124, 126) emitted by a transmission unit (12, 112) and received by the receiver unit (16, 116). The transmission unit (12, 112) emits at least two different wavelengths allocated to a common receiver (18, 118) of the receiver unit (16, 116).

The invention relates to a sensor for detecting contaminants and/or rain and a method for operating a sensor according to the preambles of the independent claims.

It is known to use opto-electronic sensor devices as detectors for contaminants or rain. Usually, such a sensor device comprises at least one transmission unit, which emits a test light, and at least one receiver unit. Contaminants deposited on the test surface influence the intensity of the test light received by the receiver unit. The transmission unit usually comprises a semi-conductor based radiation source, preferably operating in the range near infrared. Usually PIN-diodes are used as receivers, which are sensitive over a wide range of wavelengths.

Rain sensors usually operate on the basis of reflection, with a light beam being emitted at an acute angle in reference to the test surface, for example a windshield of a vehicle, and is reflected by the exterior limit layer to the receiver. When contamination occurs by an opaque medium, such as e.g. dust, the reflection features of the limit layer glass changes with regard to air and dust, additionally, light is absorbed by the dust. The light intensity measured by the receiver is reduced. When the light beam accidentally hits a raindrop on the test surface it may occur that this light beam is entirely dispersed and no intensity is registered by the receiver, which is erroneously interpreted as a one hundred percent contamination.

Contamination sensors on the basis of passing light, such as for example known from DE 10 2004 038 422 B3, operate according to the principle of a light bar. Light passes once or several times through a test surface and then hits a receiver. The level of contamination can be deduced from the intensity of the emission being known and from the actually received intensity. In case of light-blocking contamination, such as e.g., dust, the reduction of the intensity at the receiver is proportional to the level of contamination. In case of transparent contaminants, such as water or oil, the drops can act as optic elements, as described for rain sensors, and deflect the measurement beam. In geometrically disadvantageous conditions, for example when a water drop is located directly in the path of the light beam, the receiver does not receive any intensity and erroneously detects total contamination.

In common rain sensors, such faulty measurements are tolerated; a control of the windshield wipers occurs independent of the fact of dust or water being located on the windshield.

When such sensors are used, however, to adjust the light intensity of a vehicle headlight in case of a detected contamination, for example, or to perform a test of the function of the sensor such an erroneous interpretation of water drops as dust-like contaminants is disturbing.

The object of the invention is to provide a sensor for detecting dust and/or rain, in which a differentiation between water and dust is possible. Furthermore, a method for operating the sensor is to be provided.

The object is attained by the features of the independent claims. Advantageous embodiments are the object of the other claims.

A sensor for detecting contaminants and/or rain according to the invention is provided with at least one transmission unit and at least one receiver unit and one test surface, with a deposit on the test surface being detectable by light emitted by the transmission unit and received by the receiver unit. The transmission unit emits light with at least two different wavelengths, which are allocated to a common receiver of the receiver unit. By analyzing the variation of the light intensity received by the receiver as a function of the wavelengths water and dust can be distinguished. For example, water absorbs optic radiation primarily in the ultraviolet range and the longer waves of the infrared range, while it is transparent for visible light. Dust absorbs relatively independent from the wavelengths. A sensor can be provided, emitting a broadband light, or several transmitters, particularly based on semi-conductors such as light emitting diodes (LEDs), which emit almost monochromatic light but have different wavelengths. Here, light is to be understood as electromagnetic radiation with a wavelength in the range from infrared to ultraviolet. The sensor is advantageously suitable to be used in the context of light intensity control, in which the contamination of lights shall be compensated by an amplification of the emitted light intensity. An undesired increase of the light intensity by a faulty determination of contamination, in which transparent contaminants in the form of water drops are mistaken for opaque contaminants, such as dust, can be avoided. The common receiver may also comprise a group of individual, closely neighboring receivers.

Beneficially, the transmission unit is provided with at least two transmitters having different wavelengths. Common LED's can be used. It is advantageous for the transmitters to be closely neighboring each other. By a suitable positioning of the transmitters the use of different wavelengths can compensate the geometrically different paths of the light rays from the respective transmitter to the common receiver.

When a water drop is located disadvantageously on the test surface, for example directly in the radiation path between the transmitters and the common receiver it can occur that the receiver does not receive any intensity. By the different wavelengths a characteristic variation of the signal can be observed at the receiver. In the ultraviolet and the infrared range water is absorbing and is transparent in the visible range, so that a variation of the received intensity is to be expected. However, when dust is present as the deposit on the test surface in the radiation path the variation of the light intensity as a function of the wavelength is considerably lower or not existing at all.

Another sensor according to the invention for detecting contaminants and/or rain is provided with at least one transmission unit and at least one receiver unit as well as a test surface, and a deposit on the test surface can be detected by light emitted by the transmission unit and received by the receiver unit. The transmission unit comprises at least two spatially closely neighboring transmitters, allocated to a common receiver. The common receiver may also comprise a group of individual, closely neighboring receivers. The transmitters may operate either with the same wavelength or with different wavelengths as well. By the spatial offset a geometrically disadvantageously located water drop on the test surface can be detected, because it is usually locally limited and frequently a slight change in the radiation path is sufficient to cause a distinct variation in the intensity of the signals received by the receiver. The sensor is advantageously suitable to be used in the context of a light intensity control, in which any contamination of lights is to be compensated by an increase in the light intensity emitted. An undesired increase in light intensity by a faulty measurement of deposits in the form of water drops can be avoided.

When additionally the light beams emitted by the transmitters are provided with different wavelengths this variation caused by a spatial offset of the transmitters can be even enhanced.

An embodiment of the sensor as a transmitted light sensor is preferred. Such a sensor is suitable as a contaminant sensor.

It is also preferred to embody the sensor as a reflection sensor. Such a sensor is suitable as a rain sensor.

Beneficially, means may be provided to analyze a variation of the intensity of the received light beams depending on the wavelengths. Additionally or alternatively means may be provided to analyze a locally dependent variation of the intensity of the light beams received. The means can be beneficially combined with a control or adjustment unit for an adaptive light intensity control in a vehicle.

Preferably, the transmission unit can comprise a light emitting diode as the transmitter. The light emitting diodes preferably emit an almost monochromatic light.

Alternatively the transmission unit may comprise at least one broadband transmitter. In this case it is particularly beneficial when the receiver unit comprises a bandpass filter. The transmission unit may also comprise one or more transmitters emitting in a broad range of wavelengths and the receiver unit be provided with several receivers allocated to the transmitter, in such close proximity that instead of one receiver a group of receivers is provided. The signal can then be evaluated spatially or spectrally.

According to a beneficial further embodiment of the sensor the receiver unit may comprise one or more individual receivers.

One or more receivers can be temporarily synchronized with the transmission unit and/or one or more transmitters of the transmission unit. This way a spectral, wavelength-related evaluation of the received signals is possible.

Means can be allocated to one or more receivers, by which the light is detected independent from the wavelength. The means can be elements positioned upstream, in particular filters and/or prisms. The receiver can also be provided with receiver-specific features, allowing an at least predominantly wavelength independent detection of light in the desired range of wavelengths.

Additionally, the light can be spectrally evaluated by one or more receivers. Here, receivers can be used, allowing a spectral evaluation by their receiver-specific features. Receivers as the ones used in color cameras are beneficial that are capable, for example by preliminary, so-called “Beyer-Patterns,” of allocating each received wavelength over a broad band of wavelengths to a (specific) intensity.

In the method according to the invention for operating a sensor to detect contaminants and/or rain with at least one transmission unit and at least one receiver unit as well as a test surface the deposit on the test surface is detected by light emitted by the transmission unit and received by the receiver unit. A signal received by the receiver of a receiver unit is analyzed depending on its wavelength and/or the geometric origin of the transmitter or transmitters allocated thereto.

Here, a transmitter of the transmission unit can emit a broadband signal with several wavelengths or at least two transmitters of the transmission unit, which are allocated to a common receiver of the receiver unit, operating temporarily staggered.

A variation of the light intensity of the signal received is examined as the function of the wavelength and/or the geometric location of the transmitter.

When crossing a critical value of the variation in light intensity the existence of water can be detected as the deposit. In this case, when using the sensor in a device regulating light intensity the light intensity shall not be readjusted because no light-reducing contamination is given, rather the sensor is merely wet.

When a critical value of the variation in light intensity is fallen short of, the existence of dust as a contaminant can be detected. In this case a readjustment of the light intensity would be necessary. The amount of the critical value can each be individually predetermined for any given system. For example, a variation in the range of no more than 10% of the intensity can be considered uncritical.

In the following, additional advantages and details of the invention are explained in greater detail using preferred exemplary embodiments of the drawing without limiting the invention to these exemplary embodiments.

In the drawing:

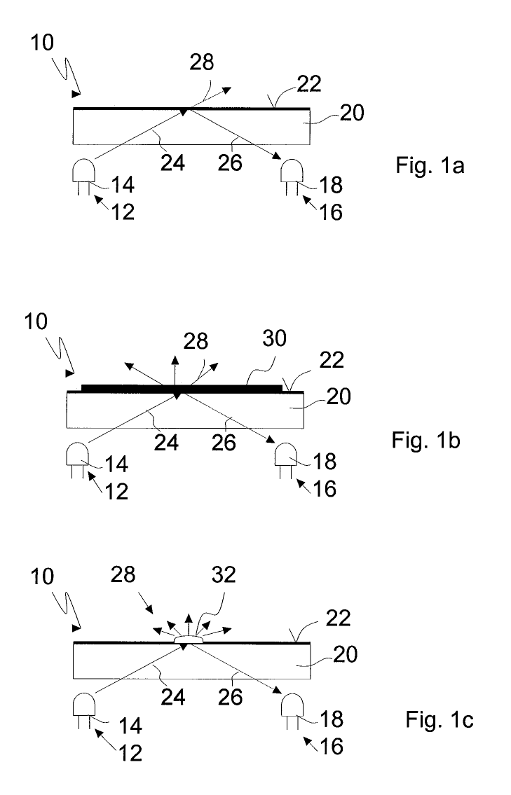

FIGS. 1a-c show schematically an illustration of distribution conditions of a light beam of a preferred sensor based on reflection with a clean test surface (a) and depending on a contamination (b, c);

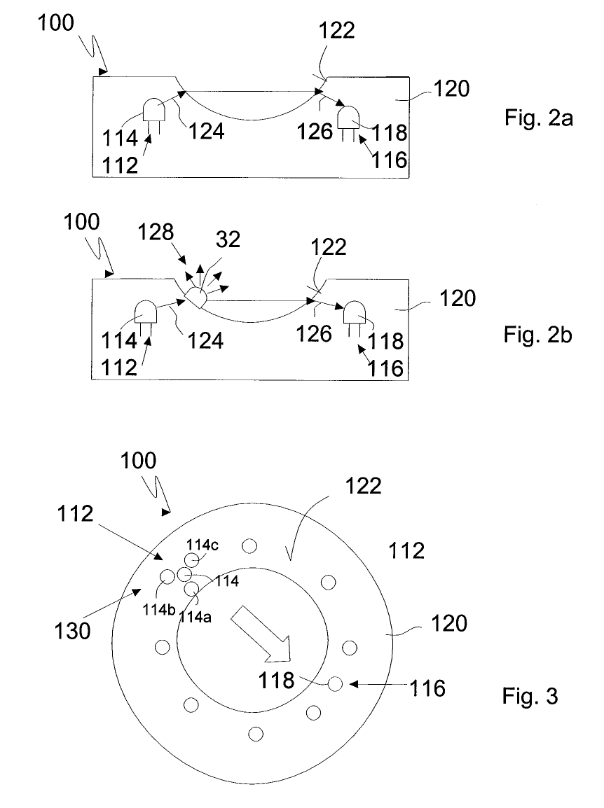

FIGS. 2a, b show schematically an illustration of distribution conditions of a light beam of a preferred sensor based on light passing over a clean test surface (a) and water being deposited (b);

FIG. 3 shows a top view of a preferred sensor based on light passing through.

In the figures elements with the same function are marked with the same reference characters.

For a better understanding of the invention, FIGS. 1a-1c explain schematically the distribution conditions of a light beam 24, 26, 28 of a preferred sensor 10 based on reflections on a clean test surface 22 (FIG. 1a) and depending on a deposit of water (FIG. 1b) and dust (FIG. 1c). Such a sensor 10 with this geometry is frequently used as a rain sensor.

A transmission unit 12 with a preferred transmitter 14 embodied as an LED emits a light beam 24, reflecting at the test surface 22 and being guided as a reflected beam 26 to the receiver 18 of a receiver unit 16. The test surface 22 is embodied as the exterior surface of a transparent test body 20, for example a glass pane. Depending on the incoming angle and/or the wavelength of the light the emitted light beam 24 is not reflected totally but a portion 28 is dispersed to the outside (FIG. 1a). The intensity of the light beam 26 received by the receiver 18 is reduced correspondingly.

When deposits 30 are provided, as shown in FIG. 1b in the form of a layer of dust, the reflected light beam 26 is weakened in its intensity to a larger extent. Depending on its thickness the deposit 30 embodied as a layer of dust, more or less absorbs a light beam 24, with also a part 28 being dispersed to the outside. The deposit 30 is typically dispersed over a relatively large surface more or less homogenously. Changes in the thickness of the deposit 30 occur relatively slowly; typically the layer of dust grows continuously over time. Signs of aging that can lead to a reduction of light intensity are slowly changing processes.

When the wavelength of the transmitter 14 is changed hardly any variation of the light intensity of the light beam 26 is to be expected. When light is emitted from a position in close proximity of the transmitter 14, again hardly any change in intensity received by the receiver 18 is to be expected as a function of the position of the transmitter 14.

In FIG. 1c the situation is shown when a deposit 32 is in the form of a water drop. At the limiting layer between the deposit 32 and the test surface 22 the refraction index changes in a manner known. A part 28 of the light exits the test surface 22 towards the outside and is dispersed by the water drop. Now, a lower light intensity hits the receiver 18 than in case of a clean test surface 22. In the extreme case no light at all hits the receiver 18, when the water drop is place disadvantageously and for example is hit directly by the light beam 24.

Although the test surface 22 then exhibits water drops they are no contamination in the narrow sense of the term, such as for example mud or dust.

When the wavelength of the transmitter 14 is changed a stronger variation of the light intensity of the light beam 26 is to be expected than in case of a layer of dust. When light is emitted from a position closely neighboring the transmitter 14, again a greater variation of the intensity received by the receiver 18 is to be expected as a function of the position of the transmitter 14, primarily when the water drops are closely limited. The light beam of a closely neighboring transmitter 14 would then potentially no longer detect the water drop, or would be disturbed less by it.

In a preferred sensor 100 the FIGS. 2a and 2b explain the ratios for passing light based on a clean test surface 122 (FIG. 2a) and with deposits 32 in the form of a water drop (FIG. 2b). The sensor 100 shown in a cross-section comprises a test body 120, in which a transmission unit 112 is arranged having at least one transmitter 114 embodied preferably as an LED and a receiver unit 116 with at least one receiver 118 embodied for example as a photodiode, as well as a curved test surface 122, with the test surface 122 comprising the light output surface of the transmission unit 112 and the light entry surface of the receiver unit 116.

The light thus passes twice through the test surface 122 before it reaches the receiver 118. The test surface 122 can even show a wavy structure, such as in DE 10 2004 038 422 B3 and can correspondingly pass frequently through the test surface 122.

It is here discernible that the intensity of the light 126 received is reduced or disadvantageously may even vanish entirely, when the deposits 32 are located disadvantageously in the path of the beams between the transmitter 112 and the receiver 116.

When dust is deposited the light intensity received in the receiver drops proportionally to the layer of dust. However, when water drops are given as deposits 32 local variations of the received light intensity are to be expected, depending where the water drops deposits. This is explained in FIG. 3 using the sensor 100 based on light passing through. The same principle is also transferable to the sensor 10 on basis of reflections in FIG. 1.

FIG. 3 shows a top view to a preferred sensor 100 of FIGS. 2a and 2b.

The transmission unit 112 comprises a multitude of transmitters 114 arranged at a circle. Between the transmitters 114 receivers 118 of the receiver unit 116 are also arranged in a circular shape, with only one receiver 118 being shown for reasons of clarity.

A group of closely neighboring additional transmitters 114a, 114b, 114c is arranged around one of the transmitters 114 in an area 130, for example. This group of transmitters 114, 114a, 114b, 114c is allocated to a single common receiver 118 of the receiver unit 116, located opposite to the group in reference to the test surface 122 curved towards the test body 120, which is indicated with the thick arrow. The group of transmitters 114, 114a, 114b, 114c logically forms a subgroup of the transmission unit 112.

The transmitters 114, 114a, 114b, 114c, preferably embodied as LEDs according to a preferred further embodiment of the invention each have a different wavelength, which can be received by the broadband receiver 118.

All transmitters 114 of the transmission unit 112 can be surrounded by additional transmitters 114a, 114b, 114c or only by some of the transmitters 114 arranged in a circle.

Commonly, the transmitters 114 are addressed one after another, for example at intervals of 100-200 ms, measuring the signal of the respectively opposite receiver 118, and thus determining the contamination of the test surface 122, so that in a measurement cycle the test surface 122 is scanned once all over.

If the deposit 32 embodied as a water drop is arranged on the area 130 of the test surface 122 over a group of transmitters 114, 114a, 114b, 114c a relatively abruptly occurring change of intensity shows, both in the temporal aspect between subsequent measurement cycles as well as within a cycle of the transmitter 114 between the signals of the individual transmitters 114.

This way, the signal of the transmitter 114 received by the respective receiver 118 right and left next to the area 130 with the deposit 32 (FIG. 2b) is clearly different from the signal of the transmitter 114 in the area 130. The adjacent transmitters 114 do not detect the water drop. When the transmitters 114a, 114b, 114c are addressed with different wavelengths, a variation of the intensity received shows over the wavelengths, because water in the infrared range and in the ultraviolet range is absorbed and is transparent in the visible range. Beneficially wavelengths are used in which the optic features of water are distinctly different.

Furthermore, the special offset of the closely neighboring transmitters 114, 114a, 114b, 114c are perhaps already sufficient to create a variation of the intensity of the signal received, because the water drops are narrowly limited in their space. If dust had precipitated on the test surface 122 the variation between the received signals of the transmitters 114, 114a, 114b, 114c would be less, and the variation between the adjacent transmitters 114 would also be low, because the dust covers the test surface 122 dispersed over an area, as experience shows.

A signal received by a receiver 118 of the receiver unit 116 can therefore be analyzed dependent on its wavelength and/or the geometric origin of the allocated transmitter or transmitters 114, 114a, 114b, 114c. Similar to this arrangement, alternatively or additionally the receiver 118 may also comprise a group of closely neighboring receivers (not shown).

For this purpose, the transmitters 114, 114a, 114b, 114c of the transmission unit 122 are operated temporarily offset and the variation of the received signal is examined as a function of the wavelength and/or the geometric location of the transmitter 114, 114a, 114b, 114c. Such a measurement cycle with additional transmitters 114a, 114b, 114c can preferably then be initiated when during a measurement cycle with “normal” transmitters 114 a maverick is observed in the measurements. Alternatively, the additional transmitters 114a, 114b, 114c can also be addressed during each measurement cycle.

When exceeding a critical value of the variation of intensity of the received light in the receiver 118 the presence of water as a deposit 32 is detected. When a critical value of the variation is fallen short of, the existence of dust as the deposit 30 is detected.

### LIST OF REFERENCE CHARACTERS

10 Sensor
12 Transmission unit
14 Transmitter
16 Receiver unit
18 Receiver
20 Test body
22 Test surface
24 Light beam
26 Light beam
28 Light beam
30 Deposit
30 Deposit
100 Sensor
112 Transmission unit
114 Transmitter
116 Receiver unit
118 Receiver
120 Test body
122 Test surface
124 Light beam
126 Light beam
128 Light beam
130 Deposit
   132 Deposit

1. A sensor for detecting contaminants and/or rain with at least one transmission unit (12, 112) and at least one receiver unit (16, 116) as well as one test surface (22, 122), in which a deposit (30, 32) on the test surface (22, 122) can be detected by a light beam (24, 26; 124, 126) emitted by the transmission unit (12, 112) and received by the receiver unit (16, 116), characterized in that the transmission unit (12, 112) emits at least two different wavelengths allocated to a common receiver (18, 118) of the receiver unit (16, 116).

2. A sensor according to claim 1, characterized in that the transmission unit (12, 112) comprises at least two transmitters (114, 114a, 114b, 114c) with different wavelengths.

3. A sensor according to claim 2, characterized in that the transmitters (114, 114a, 114b, 114c) are closely neighboring.

4. A sensor for detecting contaminants and/or rain with at least one transmission unit (12, 112) and at least one receiver unit (16, 116) as well as a test surface (22, 122) in which a deposit (30, 32) on the test surface (22, 122) can be detected by a light beam (24, 26; 124, 126) emitted by the transmission unit (12, 112) and received by the receiver unit (16, 116), characterized in that the transmission unit (12, 112) comprises at least two spatially closely neighboring transmitters (114, 114a, 114b, 114c) allocated to a common receiver (18, 118).

5. A transmitter according to claim 4, characterized in that the light beams (24, 124) emitted by the transmitter (12, 112) have different wavelengths.

6. A sensor according to one of the previous claims, characterized by an embodiment as a passing light sensor.

7. A sensor according to one of the previous claims, characterized by an embodiment as a reflection sensor.

8. A sensor according to one of the previous claims, characterized in that means are provided to analyze a variation of intensity of the received light beams (26, 126) depending on wavelengths.

9. A sensor according to one of the previous claims, characterized in that means are provided to analyze a variation in intensity of the received light beams (26, 126) depending on location.

10. A sensor according to one of the previous claims, characterized in that the transmission unit (12, 112) comprises light-emitting diodes as the transmitter (14, 114, 114a, 114b, 114c).

11. A sensor according to one of the previous claims, characterized in that the transmission unit (12, 112) comprises at least one broadband transmitter.

12. A sensor according to one of the previous claims, characterized in that the receiver unit (16, 116) comprises one or more individual receivers.

13. A sensor according to claim 12, characterized in that one or more individual receivers can by temporarily synchronized with the transmission unit (12, 112).

14. A sensor according to claim 12 or 13, characterized in that means are allocated to one or more individual receivers, allowing the detection of the light independent from the wavelengths.

15. A sensor according to one of claims 12 through 14, characterized in that the light can be spectrally evaluated by one or more individual receivers.

16. A method for operating a sensor (10, 100) to detect contaminants and/or rain with at least one transmission unit (12, 112) and at least one receiver unit (16, 116) as well as a test surface (22, 122) in which a deposit (30, 32) on the test surface (22, 122) can be detected by a light beam (24, 26; 124, 126) emitted by a transmission unit (12, 112) and received by the receiver unit (16, 116), in particular according to one of the previous claims, characterized in that a signal received by a receiver (18, 118) of the receiver unit (16, 116) is analyzed depending on its wavelength and/or the geometric origin of the allocated transmission unit or units (114, 114a, 114b, 114c).

17. A method according to claim 16, characterized in that a transmitter (14, 114) of the transmission unit (12, 112) emits a polychromatic signal.

18. A method according to claims 16 or 17, characterized in that at least two transmitters (114, 114a, 114b, 114c) of the transmission unit (12, 122) are allocated to a common receiver (18, 118) of the receiver unit (16, 116) operating temporarily offset.

19. A method according to one of claims 16 through 18, characterized in that a variation of the received signal is examined as a function of the wavelength and/or the geometric location of the transmitter (114, 114a, 114b, 114c).

20. A method according to one of claims 16 through 19, characterized in that the presence of water is detected as a deposit (32) when a critical value of the variation is crossed.

21. A method according to one of claims 16 through 20, characterized in that the presence of dust is detected as a deposit (30) when a critical value of the variation is fallen short of.

22. The use of a sensor (10, 100) according to one of claims 1 through 15 in a system to adjust the light intensity of vehicle lights.
